(19) United States
(12) Patent Application Publication
(10) Pub. No.: US 2004/0251291 A1
(43) Pub. Date: Dec. 16, 2004

(54) Dispenser for a material web that has been combined to form a unit

(76) Inventor: Thomas Bengtsson, Gullbrandstorp (SE)

Correspondence Address: Ira J. Schultz, DENNISON, SCHULTZ & DOUGHERTY, Suite 612, 1745 Jefferson Davis Highway, Arlington, VA, 22202, US

(21) Appl. No.: 10/461,884

(22) Filed: Jun. 16, 2003

(51) Int. Cl. B26F 3/02

(52) U.S. Cl. 225/27; 225/90

(57) ABSTRACT

In dispensers (1) for rolls (9) of household paper the paper web has been pulled from either the exterior or the interior of the roll. This is a drawback since, while being pulled out the strip of paper (12) becomes twisted. The present invention solves this problem in that the paper roll is rotatable about an axis perpendicular to the direction of movement of the paper web or by means of a paper unit (9) which is preferably parallel-epipedic and one end of which can be pulled out.

A material web consisting of household paper, for instance, can be combined to a unit and placed in a dispenser. The desired length of material web can be torn off from this dispenser and used for a suitable purpose. The material web can be combined to an optional unit consisting of a roll or a pleated paper web so that a parallel-epipedic unit is formed. The unit may consist of a single paper web or the paper web may be divided into portions of equal size. Hitherto household rollers of paper have been used and the paper has been obtained by the household roll being allowed to rotate about a vertical axis if the paper is removed from the exterior and the roll being stationary if the paper is removed from the interior of the roll. The reason for the desire to place said material unit in a dispenser is that there is considerable risk of theft. Taking paper from a vertical paper roll has certain drawbacks since the paper web may become tangled if it changes direction in the dispenser.

The object of the present invention is to solve the problem mentioned above and characteristic of the invention is that the material unit is so placed in the dispenser that material drawn from the material unit never changes direction. A material unit is placed in the dispenser so that the its direction of movement clearly coincides with direction of movement of the material web. This means that if, for instance, a household roll is placed in the dispenser it will rotate about a transverse axis, and the same is true of a material unit from which the material web never changes direction. In accordance with the invention a material unit is suitably placed on a transverse shelf in the dispenser, which shelf is provided with an opening in its lower side from which the paper web is drawn to the opening of the dispenser. The opening of the dispenser is provided with arrangements so that a desired length of the paper web can be torn off. When a length of paper has been torn off a substantially flat piece of the paper web is obtained.

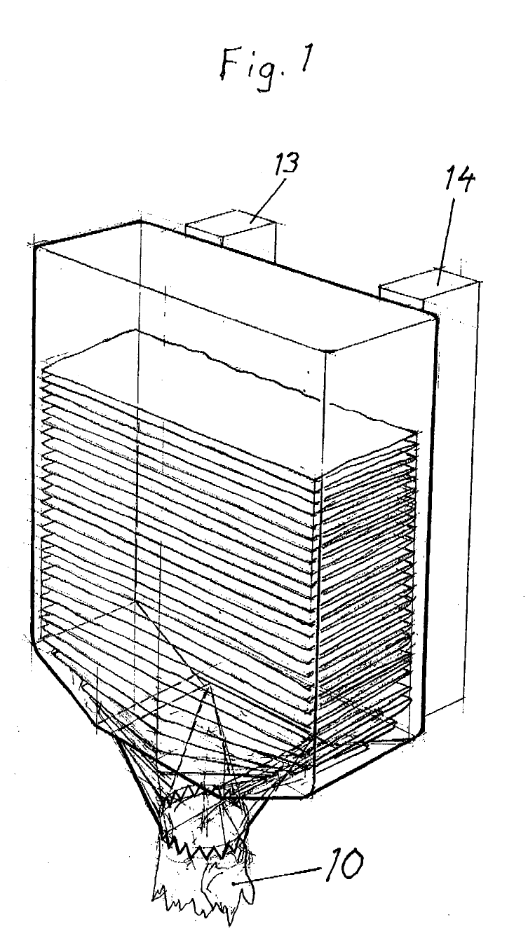

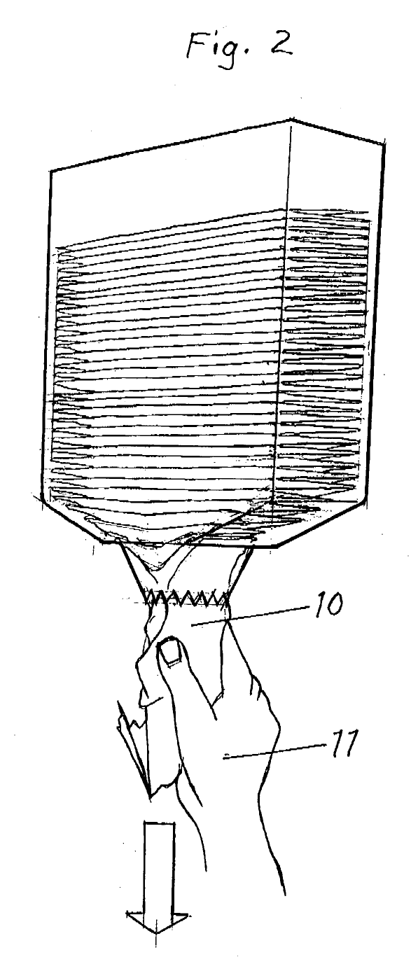

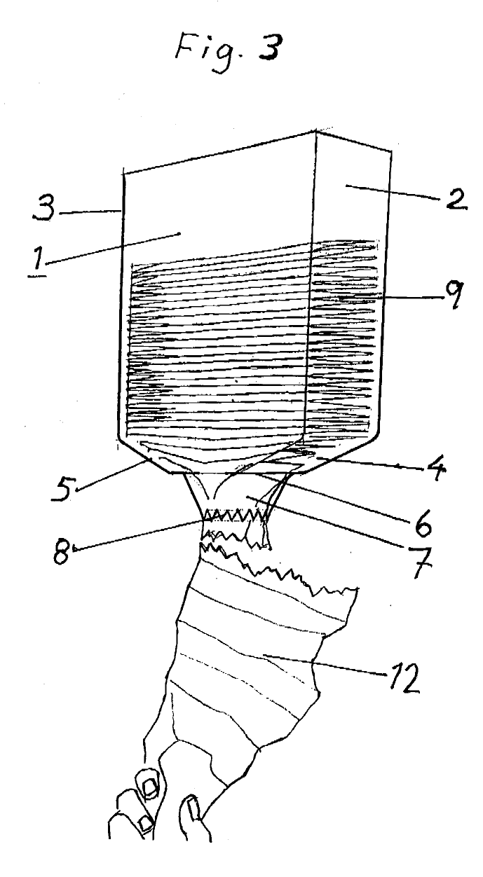

One embodiment of the present invention will be described in more detail with reference to the accompanying three figures in which FIGS. 1, 2 and 3 show a dispenser for withdrawal of a paper web in three different stages.

The drawings show a dispenser 1 for a pleated paper web 9 that is pleated to form a parallel-epipedic unit. The dispenser 1 has a rectangular cross section corresponding to the cross section of the paper unit 9. The dispenser 1 may consist of one or two parts and is generally designed to be closed and locked. Innumerable possibilities exist for manufacturing a dispenser consisting of two parts. The dispenser has two vertical side walls 2 and 3 constituting two supporting or guiding walls for the parallel-epipedic paper unit 9 of pleated paper from which a paper web is pulled off. The dispenser has a bottom consisting of two inclined walls 4 and 5, these inclined bottom parts being joined by an intermediate part 6 provided with an opening. A funnel 7 is placed in this opening and is provided at its free end with an arrangement 8 allowing this arrangement to assist in tearing off the paper web that has been withdrawn. A shelf can be placed above the funnel opening instead of the bottom illustrated. The shelf is spaced from the inlet to the funnel. This shelf has a central opening and the parts of the shelf beside the opening are designed to function as supports for the pleated paper web 9 placed on the shelf. The dispenser is intended for attachment to a wall and two spacers 13 and 14 can be used for this purpose, these being such that several spacers can be placed one on top of the other. The advantage of said spacers is that the dispenser 1 can then be placed outside external water pipes or pipes of some other type. The dispenser illustrated functions as follows.

In the drawings the pleated paper web 9 has a part protruding through the opening of the funnel 7 The protruding part of the paper web is designated 10. The hand 11 of a person can grip the protruding part 10 and pull it until the desired length 12 of paper has been obtained. The paper web 12 torn off will form a flat piece of paper as soon as it has been torn against the tear-off edge 8, and can be used immediately. The advantage of the present invention is thus that a paper web can be pulled out and torn off and a flat, rectangular piece of paper is obtained when the hand releases the paper web.

1. A dispenser consisting of an upper part, a peripheral part and a bottom part with an opening for withdrawing material stored in the dispenser, which material preferably consists of paper that may form a material web of predetermined length, characterized in that the unit is in the nature of a rolled material web of predetermined length, of a pleated material web of predetermined length or of a paper web of predetermined length concentrated in some other way, in that the unit (9) is arranged transversely in the dispenser (1) and in that the opening (6) is such that its width is less than the breadth of the paper web (9)

2. A dispenser as claimed in claim 1, characterized in that the unit (9) is spaced from the funnel opening (6).

3. A dispenser as claimed in claim 1, characterized in that at its rear side it is provided with one or more spacer elements so that the desired distance can be obtained.

4. A dispenser as claimed in claim 2, characterized in that the unit (9) rests on a shelf (4) provided with an opening.

5. A dispenser as claimed in claim 3, characterized in that the shelf (4) is provided with defining walls (2 and 3) for the unit (9).

6. A dispenser as claimed in claim 3, characterized in that from the lower side of the shelf (4) a funnel-like, preferably conical unit (7) extends, the opening of which emerges into the opening of said bottom part.

7. A dispenser as claimed in claim 5, characterized in that the outlet opening of the funnel-like unit (7) is provided with arrangements such as teeth to allow the desired length of paper to be torn off.
